(19) United States
(12) Patent Application Publication
(10) Pub. No.: US 2014/0185922 A1
(43) Pub. Date: Jul. 3, 2014

(54) IMAGE PROCESSING APPARATUS AND IMAGE PROCESSING METHOD

(71) Applicant: Kabushiki Kaisha Toshiba, Tokyo (JP)

(72) Inventor: Kenzo ISOGAWA, Tokyo (JP)

(73) Assignee: Kabushiki Kaisha Toshiba, Tokyo (JP)

(21) Appl. No.: 14/011,239

(22) Filed: Aug. 27, 2013

Related U.S. Application Data
(63) Continuation of application No. PCT/JP2013/058404, filed on Mar. 22, 2013.

(30) Foreign Application Priority Data
Dec. 27, 2012 (JP) 2012-285990

(51) Int. Cl. G06T 7/00

(52) U.S. Cl. CPC G06T 7/0051
USPC 382/154

(57) ABSTRACT

According to one embodiment, an image processing apparatus comprises an image processing unit and a control unit. The image processing unit is configured to perform image processing enhancing a depth of an imaged image. The control unit is configured to acquire an imaging condition of the imaged image and perform control such that an enhancement amount of the depth of the imaged image increases when the acquired imaging condition satisfies a predetermined depth enhancement condition.

### CROSS-REFERENCE TO RELATED APPLICATIONS

This application is a continuation of PCT international application Ser. No. PCT/JP2013/058404 filed Mar. 22, 2013 which designates the United States, incorporated herein by reference, and which claims the benefit of priority from Japanese Patent Application No. 2012-285990, filed Dec. 27, 2012, the entire contents of which are incorporated herein by reference.

### FIELD

An embodiment described herein relates generally to an image processing apparatus and an image processing method.

### BACKGROUND

Techniques have been disclosed that acquire depth information of respective image regions (e.g., portrait images and background images) included in input images and enhance depths of the respective image regions included in the input images on the basis of the acquired depth information.

In a case where an image whose depth is enhanced is an imaged image obtained by imaging by a camera, there is a demand for implementation of depth enhancement processing on the imaged image so as to reflect a user's intention to enhance the depth when the imaged image is taken.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention;

FIG. 1 is an exemplary block diagram illustrating a structure of an image processing apparatus according to an embodiment; and

FIG. 2 is an exemplary flowchart illustrating a flow of processing that controls the amount of enhancement of the depth of an imaged image in the image processing apparatus in the embodiment.

### DETAILED DESCRIPTION

In general, according to one embodiment, an image processing apparatus of an embodiment comprises an image processor and a controller. The image processor is configured to perform image processing enhancing the depth of an imaged image. The controller is configured to acquire an imaging condition of the imaged image and perform control such that an enhancement amount of the depth of the imaged image increases when the acquired imaging condition satisfies a predetermined depth enhancement condition. The enhancement amount indicates an amount of enhancing.

The following describes an image processing apparatus and an image processing method according to an embodiment with reference to the accompanying drawings.

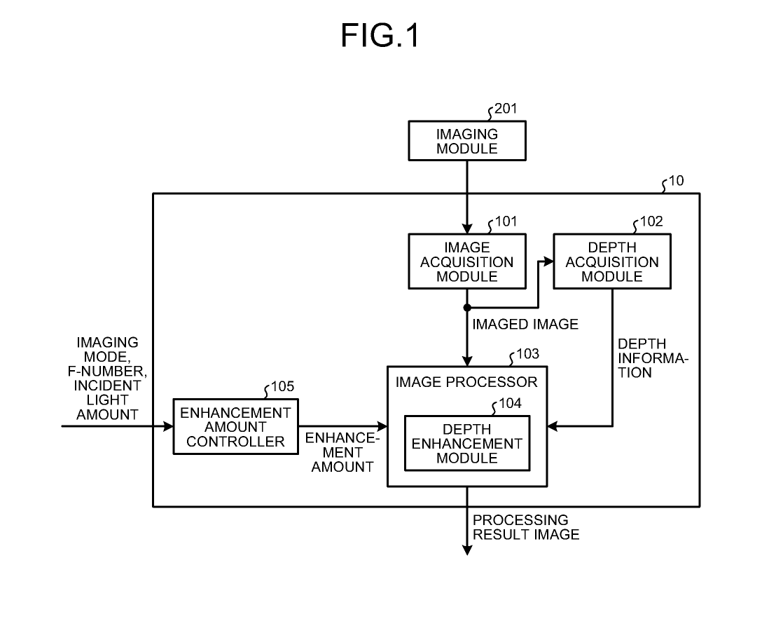

FIG. 1 is a block diagram illustrating a structure of an image processing apparatus in the embodiment. An image processing apparatus 10 in the embodiment comprises an image acquisition module 101, a depth acquisition module 102, an image processor 103, and an enhancement amount controller 105.

The image acquisition module 101 acquires the imaged image obtained by imaging a subject. In the embodiment, the image acquisition module 101 acquires the imaged image obtained by imaging by an imaging module 201 such as a camera. Various imaging conditions when the imaged image is taken are settable for the imaging module 201.

In the embodiment, the imaging conditions include an imaging mode in which a landscape or a portrait is imaged out of the imaging modes settable for the imaging module 201, an aperture value (f-number) of a lens of the imaging module 201, ISO sensitivity, which is the sensitivity of an imaging element included in the imaging module 201, a shutter speed (exposure time) of the imaging module 201, and exposure modes settable for the imaging module 201 (an aperture priority mode in which a shutter speed is set in accordance with a preset f-number, and the like).

The depth acquisition module 102 acquires depth information of the imaged image acquired by the image acquisition module 101. In the embodiment, the depth acquisition module 102 acquires the depth information indicating values of the depths of respective pixels constituting the imaged image acquired by the image acquisition module 101. The closer the distance between the imaging module 201 and the imaging target (subject) imaged by the imaging module 201, the smaller the value indicated by the depth information.

The image processor 103 performs image processing on the imaged image acquired by the image acquisition module 101. In the embodiment, the image processor 103 comprises a depth enhancement module 104 that performs imaging processing enhancing the depth of the imaged image acquired by the image acquisition module 101 in accordance with the depth information acquired by the depth acquisition module 102.

In the embodiment, the depth enhancement module 104 changes the depth enhancement processing performed on the imaged image in accordance with the value indicated by the depth information acquired by the depth acquisition module 102.

For example, the depth enhancement module 104 performs the image processing enhancing the depth of the imaged image by increasing a gain of a high frequency component of the imaged image (in other words, by setting a difference between the gain of the high frequency component of a near view image included in the imaged image and the gain of the high frequency component of a distant view image included in the imaged image) as the value indicated by the depth information becomes smaller to make an image of the subject on a near side (the near view image) in the imaged image as a sharp image and an image on a far side (the distant view image) in the imaged image as an image in which sharpness is suppressed.

The depth enhancement module 104 performs the image processing enhancing the depth of the imaged image by increasing a maximum value of a spatial frequency amplifying the near view image included in the imaged image (in other words, by setting a difference between the maximum value of the spatial frequency amplifying the near view image included in the imaged image and the maximum value of the spatial frequency amplifying the distant view image included in the imaged image) as the value indicated by the acquired depth information becomes smaller to make the near view image as a sharp image and the distant view image as an image in which sharpness is suppressed.

Furthermore, the depth enhancement module 104 can perform the image processing enhancing the depth of the imaged image by increasing intensity of removing noise included in the imaged image, i.e., reducing the amount of noise included in the imaged image (in other words, by setting a difference between the amount of noise of the near view image included in the imaged image and the amount of noise of the distant view image included in the imaged image) as the value indicated by the acquired depth information becomes larger to make the distant view image as a blurry image.

The enhancement amount controller 105 acquires the imaging conditions of the imaged image acquired by the image acquisition module 101. Then, the enhancement amount controller 105 controls the enhancement amount of the depth performed by the depth enhancement module 104 on the basis of the acquired imaging conditions. In the embodiment, the enhancement amount controller 105 acquires the imaging mode, the f-number, the ISO sensitivity, the exposure mode, the exposure time, and the like of the imaging module 201 when the imaged image is taken as the imaging conditions.

When the acquired imaging conditions satisfy predetermined depth enhancement conditions, the enhancement amount controller 105 performs control such that the enhancement amount of the depth performed by the depth enhancement module 104 increases. The predetermined depth enhancement conditions are the imaging conditions that are set by a user of the imaging module 201 so as to intend to enhance the depth of the imaged image out of the imaging conditions settable for the imaging module 201. In the embodiment, the predetermined depth enhancement conditions are that the imaging mode when the imaged image is taken is the mode for imaging a landscape or a portrait, the f-number of the lens when the imaged image is taken is smaller than a predetermined f-number, the exposure mode when the imaged image is taken is the aperture priority mode, and the like. The predetermined f-number is a value that is settable to any number by a user so as to intend to enhance the depth by setting the depth of field of the imaged image to be shallow.

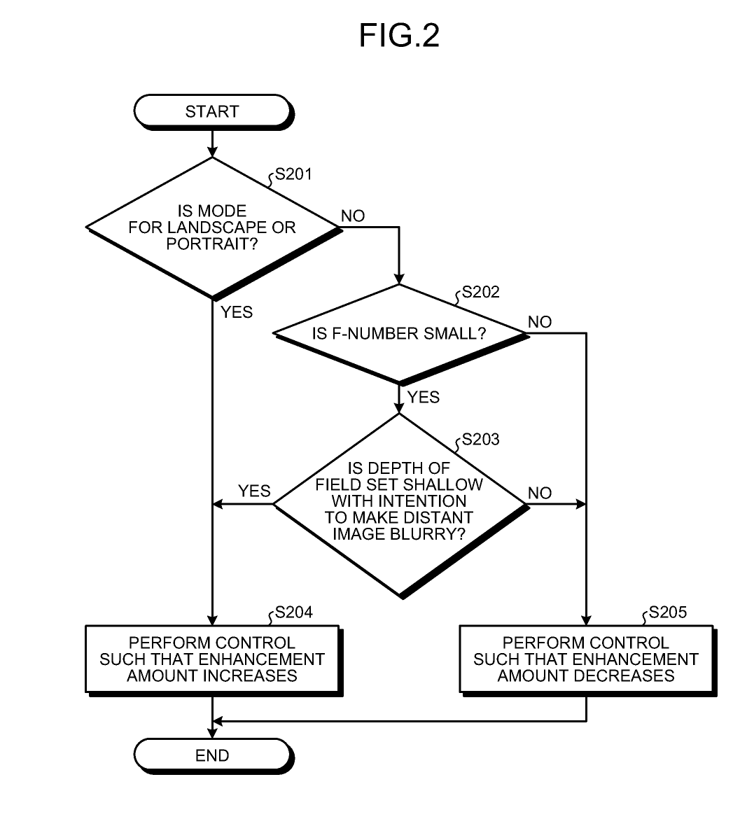

The following describes processing that controls the enhancement amount of the depth of the imaged image by the image processing apparatus 10 in the embodiment with reference to FIG. 2. FIG. 2 is a flowchart illustrating a flow of processing that controls the enhancement amount of the depth of the imaged image in the image processing apparatus in the embodiment.

When the imaged image obtained by imaging by the imaging module 201 is input, the enhancement amount controller 105 acquires the imaging mode from an Exif tag of an Exif image file of the input imaged image as the imaging condition. The Exif tag includes a scene capture type tag indicating whether the imaging mode when the imaging module 201 images a subject is the mode for imaging a landscape or a person (portrait). The enhancement amount controller 105 refers to the scene capture type tag included in the Exif tag of the Exif image file of the input imaged image and determines whether the imaging mode when the imaged image is taken is the mode for imaging a landscape or a portrait (S201).

If the imaging mode when the imaged image is taken is the mode for imaging a landscape or a portrait (Yes at S201), the enhancement amount controller 105 controls the depth enhancement processing performed by the depth enhancement module 104 such that the enhancement amount of the depth of the imaged image increases (S204).

When the imaging mode when the imaged image is taken is the mode for imaging a landscape, it is intended to express a broadening of the subject (landscape) in the imaged image (in other words, to enhance the depth of the imaged image). The enhancement amount controller 105 thus performs the control such that the enhancement amount of the depth of the imaged image increases. When the imaging mode when the imaged image is taken is the mode for imaging a portrait, it is intended to express the importance of the near view image (image of a person) included in the imaged image (in other words, to enhance the depth of the imaged image). The enhancement amount controller 105 thus performs the control such that the enhancement amount of the depth of the imaged image increases.

In the embodiment, the enhancement amount controller 105 performs control such that the enhancement amount of the depth increases by controlling the amplification of the respective high frequency components of the near view image and the distant view image performed by the depth enhancement module 104 such that the difference increases between the gain of the high frequency component of the near view image included in the imaged image and the gain of the high frequency component of the distant view image included in the imaged image. As a result, the near view image included in the imaged image is made as a sharper image while the distant view image included in the imaged image is made as an image in which sharpness is further suppressed, thereby further enhancing the depth of the imaged image.

The enhancement amount controller 105 may perform control such that the enhancement amount of the depth increases by controlling the amplification of the respective spatial frequencies of the near view image and the distant view image performed by the depth enhancement module 104 such that the difference increases between the maximum value of the spatial frequency amplifying the near view image included in the imaged image and the maximum value of the spatial frequency amplifying the distant view image included in the imaged image. As a result, the near view image included in the imaged image is made as a sharper image while the distant view image included in the imaged image is made as an image in which sharpness is further suppressed, thereby further enhancing the depth of the imaged image.

The enhancement amount controller 105 may perform control such that the enhancement amount of the depth increases by controlling the intensity of noise removal of the respective near view image and the distant view image performed by the depth enhancement module 104 such that the difference increases between the amount of noise of the near view image included in the imaged image and the amount of noise of the distant view image included in the imaged image. As a result, the distant view image included in the imaged image is made as a blurrier image, thereby further enhancing the depth of the imaged image.

On the other hand, if the imaging mode when the imaged image is taken is not the mode for imaging a landscape or a portrait (No at S201), the enhancement amount controller 105 acquires the f-number of the lens when the imaged image is taken from the Exif tag of the Exif image file. The enhancement amount controller 105 determines whether the acquired f-number is smaller than a predetermined f-number (S202).

In the embodiment, when controlling the enhancement processing such that the enhancement amount of the depth of the imaged image increases, the enhancement amount controller 105 controls the enhancement processing such that the enhancement amount of the depth of the imaged image becomes a maximum enhancement amount Vmax that is a maximum value of a preset enhancement amount.

If the acquired f-number is larger than the predetermined f-number (No at S202), the enhancement amount controller 105 controls the depth enhancement processing performed by the depth enhancement module 104 such that the enhancement amount of the depth of the imaged image decreases because the depth of the field of the imaged image is deep and thus the imaging is not performed so as to intend to enhance the depth of the imaged image (S205). In the embodiment, the enhancement amount controller 105 controls the depth enhancement module 104 such that the enhancement amount of the depth of the imaged image decreases. The control, however, is not limited to this manner. The enhancement amount of the depth of the imaged image may not be decreased.

In the embodiment, the enhancement amount controller 105 performs control such that the enhancement amount of the depth decreases by controlling the amplification of the respective high frequency components of the near view image and the distant view image performed by the depth enhancement module 104 such that the difference decreases between the gain of the high frequency component of the near view image included in the imaged image and the gain of the high frequency component of the distant view image included in the imaged image. The enhancement amount controller 105 may perform control such that the enhancement amount of the depth decreases by controlling the amplification of the respective spatial frequencies of the near view image and the distant view image performed by the depth enhancement module 104 such that the difference decreases between the maximum value of the spatial frequency amplifying the near view image included in the imaged image and the maximum value of the spatial frequency amplifying the distant view image included in the imaged image. The enhancement amount controller 105 may perform control such that the enhancement amount of the depth decreases by controlling the intensity of noise removal of the respective near view image and the distant view image performed by the depth enhancement module 104 such that the difference decreases between the amount of noise of the near view image included in the imaged image and the amount of noise of the distant view image included in the imaged image.

In the embodiment, when controlling the enhancement processing such that the enhancement amount of the depth of the imaged image decreases, the enhancement amount controller 105 controls the enhancement processing such that the enhancement amount of the depth of the imaged image becomes a minimum enhancement amount Vmin that is a minimum value of a preset enhancement amount and smaller than the maximum enhancement amount Vmax.

If the acquired f-number is smaller than the predetermined f-number (Yes at S202), the enhancement amount controller 105 acquires the exposure mode from the Exif tag of the Exif image file. When the acquired exposure mode is the aperture priority mode, the enhancement amount controller 105 determines that the depth of field is shallow because of the intention to make the distant view image of the imaged image blurry (Yes at S203) and controls the depth enhancement processing performed by the depth enhancement module 104 such that the enhancement amount of the depth of the imaged image increases (S204).

When the exposure mode is the aperture priority mode, an f-number arbitrarily set by a user is set to the f-number of the lens when the imaged image is taken. When the arbitrarily set f-number is smaller than the predetermined f-number, it is thought that the user sets the f-number smaller with the intention to obtain the imaged image whose depth of field is shallow (i.e., the imaged image whose depth is enhanced) . Therefore, when the acquired f-number is smaller than the predetermined f-number and the exposure mode is the aperture priority mode, the enhancement amount controller 105 determines that the depth of field is set to be shallow with the intention to make the distant image blurry.

In the embodiment, the enhancement amount controller 105 determines whether the depth of field is set to be shallow with the intention to make the distant image blurry on the basis of the acquired f-number and exposure mode. The determination, however, is not limited to this manner. For example, the enhancement amount controller 105 may determine whether the depth of field is set to be shallow with the intention to make the distant image blurry using the ISO sensitivity, the exposure time, and the like in addition to the acquired f-number. Specifically, when the acquired f-number is smaller than the predetermined f-number and the acquired ISO sensitivity is high (or the acquired exposure time is long), the enhancement amount controller 105 determines that the f-number is set to be small so as to prevent underexposure of the imaged image by increasing an incident light amount entering the optical system of the imaging module 201 (i.e., determines that the depth of field is set to be shallow without the intention to make the distant view blurry).

In the embodiment, the enhancement amount controller 105 determines whether the depth of field is set to be shallow with the intention to make the distant image blurry on the basis of the acquired f-number and exposure mode (or the ISO sensitivity, the exposure time, and the like) . The enhancement amount controller 105, however, may determine whether the depth of field is set to be shallow with the intention to make the distant image blurry on the basis of only the acquired f-number. That is, when the acquired f-number is smaller than the predetermined f-number, the enhancement amount controller 105 determines that the depth of field is set to be shallow with the intention to make the distant image blurry and controls the depth enhancement module 104 such that the enhancement amount of the depth of the imaged image increases.

When the acquired exposure mode is the mode other than the aperture priority mode, the enhancement amount controller 105 determines that the depth of field is set shallow without the intention to make the distant view image of the imaged image blurry (i.e., the depth of field is set shallow so as to prevent the underexposure of the imaged image) (No at 5203) and controls the depth enhancement processing performed by the depth enhancement module 104 such that the enhancement amount of the depth of the imaged image decreases (S205).

In the embodiment, the enhancement amount controller 105 switches the enhancement amount of the depth of the imaged image to the maximum enhancement amount Vmax or the minimum enhancement amount Vmin in accordance with whether the acquired imaging conditions satisfy the predetermined depth enhancement conditions. The control, however, is not limited to this manner.

For example, the enhancement amount controller 105 may control the enhancement of the depth performed by the depth enhancement module 104 on the basis of the imaging conditions of the imaged image regardless of whether the imaging conditions of the imaged image that serves as the enhancement target and the depth of which is enhanced by the depth enhancement module 104 satisfy the predetermined depth enhancement conditions. Specifically, the enhancement amount controller 105 determines the enhancement amount of the depth performed by the depth enhancement module 104 using the imaging conditions of the imaged image. Then, the enhancement amount controller 105 controls the enhancement amount of the depth performed by the depth enhancement module 104 on the basis of the determined enhancement amount. The following describes an example of a method of determining an enhancement amount V using the imaging conditions of the imaged image.

The enhancement amount controller 105 determines an enhancement amount V0 calculated in accordance with expression (1) using the imaging conditions (the imaging mode, the exposure mode, the f-number, the ISO sensitivity, and the exposure time) acquired from the Exif tag as the enhancement amount V of the depth.

V0=A*Vmode0+B*(C+Vmode1)*Vf−D*Viso−E*Vt (1)

Vmode: “1” in the case that the imaging mode is the mode for imaging a landscape or a portrait, or “0” in the other imaging modes

Vmode1: “1” in the case that the exposure mode is the aperture priority mode or “0” in the other exposure modes

Vf: f-number

Viso: ISO sensitivity

Vt: exposure time

A to E: constants

When the enhancement amount V0 calculated by expression (1) is larger than the maximum enhancement amount Vmax, the enhancement amount controller 105 determines the maximum enhancement amount Vmax as the enhancement amount V of the depth.

On the other hand, when the enhancement amount V0 is smaller than the minimum enhancement amount Vmin, the enhancement amount controller 105 determines the minimum enhancement amount Vmin as the enhancement amount V of the depth. When the enhancement amount V0 is equal to or smaller than the maximum enhancement amount Vmax and equal to or larger than the minimum enhancement amount Vmin, the enhancement amount controller 105 determines the enhancement amount V0 as the enhancement amount V.

When the acquired imaging conditions satisfy the predetermined depth enhancement conditions, the enhancement amount controller 105 controls the enhancement of the depth performed by the depth enhancement module 104 on the basis of the imaging conditions of the acquired imaging conditions. On the other hand, when the acquired imaging conditions do not satisfy the predetermined depth enhancement conditions, the enhancement amount controller 105 may not control the enhancement of the depth performed by the depth enhancement module 104.

As described above, the image processing apparatus 10 of the embodiment can implement the depth enhancement processing on the imaged image with reflection of a user's intention to enhance the depth when the imaged image is taken by acquiring the imaging conditions of the imaged image and controlling the enhancement amount of the depth of the imaged image performed by the image processor 103 (the depth enhancement module 104) when the acquired imaging conditions satisfy the predetermined depth enhancement conditions.

A program executed by the image processing apparatus 10 of the embodiment is provided by being preliminarily stored in a read only memory (ROM) or the like.

The program executed by the image processing apparatus 10 of the embodiment may be recorded into a recording medium readable by a computer with a format installable in or a file executable by a computer, such as a CD-ROM, a flexible disk (FD), a CD-R, and a digital versatile disk (DVD), and be provided.

The program executed by the image processing apparatus 10 of the embodiment may be stored in a computer coupled with a network such as the Internet, and be provided by being downloaded through the network. The program executed by the image processing apparatus 10 of the embodiment may be provided or delivered through a network such as the Internet.

The program executed by the image processing apparatus 10 of the embodiment has a module structure comprising the above-described components (the image acquisition module 101, the depth acquisition module 102, the image processor 103, the depth enhancement module 104, the enhancement amount controller 105, and the like). In actual hardware, a CPU (processor) reads the program from the ROM and executes the program, resulting in the above-described components being loaded into a main storage, and the image acquisition module 101, the depth acquisition module 102, the image processor 103, the depth enhancement module 104, the enhancement amount controller 105 being formed in the main storage.

While the embodiment of the present invention has been described, the embodiment has been presented by way of an example only, and is not intended to limit the scope of the invention. The embodiment described herein may be embodied in a variety of other forms. Furthermore, various omissions, substitutions and changes of the embodiment described herein may be made without departing from the spirit of the invention. The accompanying claims and their equivalents are intended to cover the embodiment as would fall within the scope and spirit of the invention.

What is claimed is:

1. An image processing apparatus, comprising:
an image processor configured to perform image processing enhancing a depth of an imaged image; and
a controller configured to acquire an imaging condition of the imaged image and perform control such that an enhancement amount of the depth of the imaged image increases when the acquired imaging condition satisfies a predetermined depth enhancement condition, the enhancement amount indicating an amount of enhancing.

2. The image processing apparatus of claim 1, wherein
the predetermined depth enhancement condition is that an imaging mode when the imaged image is taken is a mode for imaging a landscape or a portrait, and
the controller is configured to acquire the imaging mode when the imaged image is taken as the imaging condition and perform control such that the enhancement amount increases when the imaging mode is the mode for imaging a landscape or a portrait.

3. The image processing apparatus of claim 1, wherein
the predetermined depth enhancement condition is that an aperture value of a lens when the imaged image is taken is smaller than a predetermined aperture value, and
the controller is configured to acquire the aperture value of the lens when the imaged image is taken as the imaging condition and perform control such that the enhancement amount increases when the acquired aperture value is smaller than the predetermined aperture value.

4. The image processing apparatus of claim 1, wherein
the predetermined depth enhancement condition is that an exposure mode when the imaged image is taken is an aperture priority mode, and
the controller is configured to acquires an aperture value of a lens when the imaged image is taken, acquire the exposure mode when the imaged image is taken as the imaging condition when the acquired aperture value is smaller than a predetermined aperture value and perform control such that the enhancement amount increases when the acquired exposure mode is the aperture priority mode.

5. The image processing apparatus of claim 1, wherein
the image processor is configured to perform the image processing that enhances the depth of the imaged image on the basis of a difference between a gain of a high frequency component of a near view included in the imaged image and a gain of a high frequency component of a distant view included in the imaged image, and
the controller is configured to perform control such that the enhancement amount increases by increasing the difference between the gain of the high frequency component of the near view included in the imaged image and the gain of the high frequency component of the distant view included in the imaged image.

6. The image processing apparatus of claim 1, wherein
the image processor is configured to perform the image processing that enhances the depth of the imaged image on the basis of a difference between a maximum value of a space frequency amplifying a near view included in the imaged image and a maximum value of a space frequency amplifying a distant view included in the imaged image, and
the controller is configured to perform control such that the enhancement amount increases by increasing the difference between the maximum value of the space frequency amplifying the near view included in the imaged image and the maximum value of the space frequency amplifying the distant view included in the imaged image.

7. The image processing apparatus of claim 1, wherein
the image processor is configured to perform the image processing that enhances the depth of the imaged image on the basis of a difference between an amount of noise of a near view included in the imaged image and an amount of noise of a distant view included in the imaged image, and
the controller is configured to perform control such that the enhancement amount increases by increasing the difference between the amount of noise of the near view included in the imaged image and the amount of noise of the distant view included in the imaged image.

8. An image processing method, comprising:
performing image processing enhancing a depth of an imaged image; and
acquiring an imaging condition of the imaged image and performing control such that an enhancement amount of the depth of the imaged image increases when the acquired imaging condition satisfies a predetermined depth enhancement condition, the enhancement amount indicating an amount of enhancing.
